(19) United States
(12) Patent Application Publication
(10) Pub. No.: US 2024/0166078 A1
(43) Pub. Date: May 23, 2024

(54) INFORMATION MANAGEMENT SYSTEM AND INFORMATION MANAGEMENT METHOD

(71) Applicant: TOYOTA JIDOSHA KABUSHIKI KAISHA, Toyota-shi (JP)

(72) Inventors: Hideki TAMOTO, Toyota-shi (JP); Akinori MORISHIMA, Naka-gun (JP); Masami SUGANUMA, Miyoshi-shi (JP); Taiki MIYAZAKI, Nagoya-shi (JP); Masakazu MOTOHASHI, Nagoya-shi (JP)

(73) Assignee: TOYOTA JIDOSHA KABUSHIKI KAISHA, Toyota-shi (JP)

(21) Appl. No.: 18/468,799

(22) Filed: Sep. 18, 2023

(30) Foreign Application Priority Data
Nov. 21, 2022 (JP) 2022-185737

(51) Int. Cl. B60L 53/66; B60L 53/68; G06Q 10/02

(52) U.S. Cl. CPC B60L 53/665; B60L 53/68; G06Q 10/02; B60L 2240/62; B60L 2240/70

(57) ABSTRACT

An information management system including a server. The server is configured to manage reservation information for reserving use of a charging device configured to charge a power storage device mounted on a battery electric vehicle. The server is configured to receive information for temporarily providing an authority for use of the battery electric vehicle to a renting person that rents the battery electric vehicle during a reservation time.

### CROSS-REFERENCE TO RELATED APPLICATION

This application claims priority to Japanese Patent Application No. 2022-185737 filed on Nov. 21, 2022 incorporated herein by reference in its entirety.

### BACKGROUND

### 1. Technical Field

The present disclosure relates to an information management system and an information management method.

### 2. Description of Related Art

When a power storage device mounted on a vehicle is charged using a charging station installed at a facility other than home, it is possible to make effective use of a waiting time until charging is completed by using services provided around the charging station. To that end, use of a charging station is occasionally reserved in consideration of use of such services.

For example, WO 2020/194456 discloses a technique of extracting services that are available at a candidate destination of a user when the candidate destination is recognized and transmitting candidate destination information including such services to a user terminal. This allows the user to select an available service to be used during the waiting time at the destination, helping effectively use the waiting time.

### SUMMARY

A charging station may be occupied for a long period when a user that has reserved use of the charging station uses other services as discussed above or goes out for a trip after connecting a vehicle to the reserved charging station at an airport etc. On such occasions, the charging station cannot be used by other users while being occupied, and therefore the charge schedule may not be used effectively.

The present disclosure provides an information management system and an information management method that allow effective use of a vehicle and a charging device that charges a power storage device mounted on the vehicle when the charging device is occupied for a long period.

A first aspect of the present disclosure provides an information management system including a server. The server is configured to manage reservation information for reserving use of a charging device configured to charge a power storage device mounted on a battery electric vehicle. The server is configured to receive information for temporarily providing an authority for use of the battery electric vehicle to a renting person that rents the battery electric vehicle during a reservation time.

According to the above configuration, the server receives information for temporarily providing an authority for use of the battery electric vehicle to the renting person of the battery electric vehicle when the use of the charging device is reserved, and therefore the renting person is allowed to use the battery electric vehicle during the period of the use of the charging device. In addition, the charging device can be used during use of the battery electric vehicle by the renting person, and therefore the vehicle and the charging device can be used effectively when a reservation is made for a long period of the use of the charging device.

In the information management system according to the first aspect of the present disclosure, the server may be configured to set a set period set within a reserved period of the use of the charging device as a first period during which the renting person is enabled to use the battery electric vehicle.

According to the above configuration, the first period is set within the period of the use of the charging device, and therefore the renting person is allowed to use the battery electric vehicle during the first period, and the charging device can be used during use of the battery electric vehicle by the renting person. Therefore, the vehicle and the charging device can be used effectively when a reservation is made for a long period of the use of the charging device.

In the information management system according to the first aspect of the present disclosure, the server may be configured to set a set period set within a reserved period of the use of the charging device as one of a first period during which the renting person is enabled to use the battery electric vehicle and a second period during which power supply and demand is adjusted.

According to the above configuration, when the first period is set as the set period, the renting person is allowed to use the battery electric vehicle during the first period, and the charging device can be used during use of the battery electric vehicle by the renting person. When the second period is set as the set period, further, the battery electric vehicle can be used to adjust power supply and demand, achieving balance between power supply and demand.

The information management system according to the first aspect of the present disclosure may further include a terminal configured to communicate with the server. The terminal may be configured to transmit a digital key to the server as the information for temporarily providing the authority for use of the battery electric vehicle when reserving the use of the charging device, the digital key enabling the battery electric vehicle to be rented for a set period set within a period of the use of the charging device.

According to the above configuration, the renting person is allowed to use the battery electric vehicle during the period of the use of the charging device, by transmitting the digital key from the terminal to the server when the use of the charging device is reserved.

In the information management system according to the first aspect of the present disclosure, the server may be configured to acquire information on at least one of a use history of the battery electric vehicle and a state of the battery electric vehicle during a period of the use of the charging device from the battery electric vehicle. The server may be configured to set a charge schedule for the power storage device using the acquired information.

According to the above configuration, the charge schedule of the power storage device is set using information on the use history of the battery electric vehicle or the state of the battery electric vehicle during the period of the use of the charging device, and therefore the state of the power storage device can be brought to a state (e.g. a fully charged state) determined in advance when the period of the use of the charging device is finished.

A second aspect of the present disclosure provides an information management system including a terminal. The terminal is configured to notify a user that uses a battery electric vehicle of reservation information for reserving use of a charging device configured to charge a power storage device mounted on the battery electric vehicle. The terminal is configured to transmit information for temporarily providing an authority for use of the battery electric vehicle to a renting person that rents the battery electric vehicle during a reservation time.

According to the above configuration, information for temporarily providing an authority for use of the battery electric vehicle is transmitted to the renting person of the battery electric vehicle during the reservation time, and therefore the renting person is allowed to use the battery electric vehicle during the period of the use of the charging device. In addition, the charging device can be used during use of the battery electric vehicle by the renting person, and therefore the vehicle and the charging device can be used effectively when a reservation is made for a long period of the use of the charging device.

A third aspect of the present disclosure provides an information management method, including: a server managing reservation information for reserving use of a charging device configured to charge a power storage device mounted on a battery electric vehicle; and the server receiving information for temporarily providing an authority for use of the battery electric vehicle to a renting person that rents the battery electric vehicle during a reservation time.

According to the present disclosure, it is possible to provide an information management system and an information management method that allow effective use of a vehicle and a charging device that charges a power storage device mounted on the vehicle when the charging device is occupied for a long period.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 illustrates an example of the configuration of an information management system;

FIG. 2 is a flowchart illustrating an example of a process executed by a first terminal;

FIG. 3 is a flowchart illustrating an example of a process of registering reservation information executed by a management server;

FIG. 4 is a flowchart illustrating an example of a process of reserving shared use executed by the management server;

FIG. 5 is a flowchart illustrating an example of a process of transmitting a time-limited digital key executed by the management server;

FIG. 6 is a flowchart illustrating an example of a process of setting a participant vehicle for a DR request executed by the management server;

FIG. 7 is a flowchart illustrating an example of a process of setting a charge schedule executed by the management server;

FIG. 8 is a flowchart illustrating an example of a process of setting a parking fee executed by the management server; and

FIG. 9 is a timing chart illustrating an example of operation of the management server for a case where only shared use is permitted.

### DETAILED DESCRIPTION OF EMBODIMENTS

An embodiment of the present disclosure will be described in detail below with reference to the drawings. The same or corresponding portions are denoted by the same signs throughout the drawings, and description thereof will not be repeated.

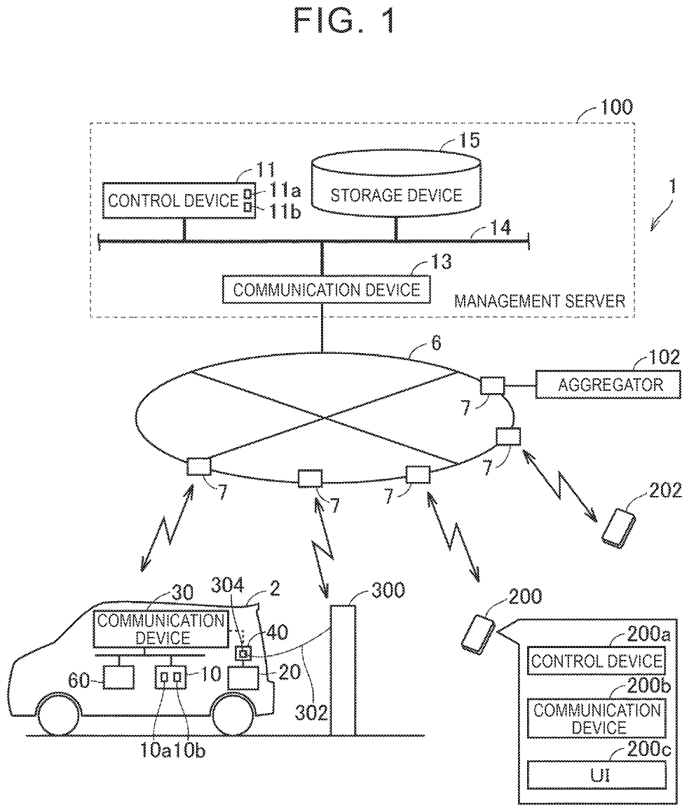

FIG. 1 illustrates an example of the configuration of an information management system 1. In the present embodiment, as illustrated in FIG. 1, the information management system 1 includes a vehicle 2, a communication network 6, base stations 7, a management server 100, a first terminal 200, a second terminal 202, and a charging/discharging station 300.

The vehicle 2 may be a vehicle that includes an engine as a drive source, a battery electric vehicle that includes an electric motor as a drive source, or a hybrid electric vehicle that includes an engine and an electric motor and that is driven by at least one of the engine and the electric motor, for example. While a single vehicle 2 is illustrated as a vehicle managed by the management server 100 in FIG. 1 for convenience, the number of vehicles managed by the management server 100 is not specifically limited to one, and may be two or more.

The information management system 1 is configured to manage information determined in advance acquired from or provided to the vehicle 2 configured to be capable of communicating with the management server 100.

The management server 100 includes a control device 11, a communication device 13, and a storage device 15. The control device 11, the communication device 13, and the storage device 15 are communicably connected to each other through a communication bus 14.

The control device 11 is configured to include a processor 11a that executes a program such as a central processing unit (CPU), a memory 11b (such as a read only memory (ROM) and a random access memory (RAM)), input and output ports (not illustrated) for input and output of various types of signals, etc. Various types of control executed by the control device 11 are executed through software processing, that is, by the CPU 11a reading a program stored in the memory 11b. The various types of control by the control device 11 can also be implemented by a general-purpose computer (not illustrated) executing a program stored in a storage medium. The various types of control by the control device 11 may be processed by dedicated hardware (electronic circuit), rather than software processing.

The storage device 15 stores information determined in advance about the vehicle 2 configured to be capable of communicating with the management server 100. Examples of the information determined in advance include information about a control program for the vehicle 2 to be discussed later, and information (hereinafter referred to as a “vehicle identifier (ID)”) for specifying the vehicle 2. The vehicle ID is peculiar information set for each vehicle. The management server 100 can specify a vehicle as the transmission source or the transmission destination using the vehicle ID.

The communication device 13 implements bidirectional communication between the control device 11 and the communication network 6. The management server 100 enables communication with the vehicle 2, on which the communication device 30 is mounted, using the communication device 13 via the base stations 7 provided on the communication network 6. Further, the management server 100 enables communication with the first terminal 200 and the second terminal 202 using the communication device 13 via the base stations 7 provided on the communication network 6.

The first terminal 200 is a portable terminal such as a smartphone, a tablet terminal, or a wearable device owned by a user of the vehicle 2, for example. The first terminal 200 includes a control device 200a that includes a processor that executes a program such as a CPU and a memory, a communication device 200b configured to be capable of communicating with the management server 100 by way of the base stations 7, and a user interface (hereinafter referred to as a “UI”) 200c. The UI 200c includes a display device that displays information determined in advance, and a touch panel that receives an operation by the user, for example. The first terminal 200 stores information about a digital key for unlocking doors of the vehicle 2 and performing driving operations in correlation with the vehicle ID of the vehicle 2. The digital key of the first terminal 200 is authenticated for the vehicle 2 by the user performing an operation determined in advance using the first terminal 200 around the vehicle 2, for example, allowing unlocking the doors of the vehicle 2 and performing driving operations etc.

The management server 100 stores identification information (e.g. a telephone number, a media access control (MAC) address, etc.) for specifying the first terminal 200 and the vehicle ID of the vehicle 2 in correlation with each other, for example.

The second terminal 202 is a portable terminal such as a smartphone, a tablet terminal, or a wearable device owned by a user that uses a vehicle rental service such as car rental and car sharing, for example The second terminal 202 is a computer that includes a processor that executes a program such as a CPU (not illustrated), a memory, and an input/output interface (not illustrated). The second terminal 202 is configured to be capable of communicating with the management server 100 by way of the base stations 7. The second terminal 202 is configured similarly to the first terminal 200. Therefore, detailed description thereof will not be repeated.

The charging/discharging station 300 is provided in at least one of a plurality of parking spaces provided in a parking lot of a facility such as an airport, for example. In FIG. 1, one charging/discharging station 300 is illustrated as a representative.

A power line (not illustrated) connected to a power network is connected to the charging/discharging station 300. One end of a cable 302 is connected to the charging/discharging station 300. A connector 304 is connected to the other end of the cable 302. The connector 304 is structured to be connectable to an inlet 40 of the vehicle 2. FIG. 1 illustrates the connector 304 being connected to the inlet 40 of the vehicle 2.

When the connector 304 is connected to the inlet 40, power can be exchanged between the charging/discharging station 300 and the power storage device 20 of the vehicle 2. The charging/discharging station 300 includes a control device and a communication device (neither illustrated), and is configured to be capable of communicating with the management server 100 by way of the base stations 7 and the communication network 6, for example.

The information management system 1 further includes an aggregator server 102. The aggregator server 102 is a server owned by a business operator as a lower-level aggregator (resource aggregator), for example. The lower-level aggregator is a business operator that controls small-scale power supply facilities, including the charging/discharging station 300, via the management server 100 in accordance with a request (hereinafter occasionally referred to as a demand response (DR) request) for power supply and demand adjustment from an upper layer (e.g. a higher-level aggregator (aggregation coordinator), a power transmission and distribution operator (power company), etc.). The aggregator server 102 performs supply and demand adjustment using small-scale power supply facilities in a power network to be subjected to the supply and demand adjustment in accordance with the DR request, and provides an incentive corresponding to a contribution to the owner etc. of each small-scale power supply facility.

Next, a specific configuration of the vehicle 2 will be described. The vehicle 2 includes drive wheels and driven wheels. When the drive source operates, the drive wheels are rotated and a drive force acts on the vehicle 2 to cause the vehicle 2 to travel.

The vehicle 2 further includes an electronic control unit (ECU) 10, the power storage device 20, the communication device 30 constituted of a data communication module (DCM) etc., the inlet 40, and the navigation system 60.

The ECU 10 is a computer that includes a processor 10a that executes a program such as a CPU, a memory 10b, and an input/output interface (not illustrated). The ECU 10 includes various types of control programs for controlling various types of actuators mounted on the vehicle 2. The various types of control programs include a control program for at least one of steering control, drive control, and braking control, for example. The various types of control programs may include a program for executing a drive assistance system that has a function about drive assistance for the vehicle 2, for example.

The power storage device 20 is a direct-current power source configured to be rechargeable, and is constituted by a secondary battery such as a nickel-hydrogen battery or a lithium-ion battery that contains a solid or liquid electrolyte, a capacitor, etc., for example.

The communication device 30 is configured to be capable of bidirectional communication with the management server 100 by way of the communication network 6 and the base stations 7.

The navigation system 60 includes a position detection device that specifies the position of the vehicle 2 using global positioning system (GPS) satellites, a wireless local area network (LAN), etc., a database that stores map information and a travel history, and a control device that includes a CPU etc. (none illustrated), for example. The navigation system 60 specifies a travel route on a map from the present position of the vehicle 2 to a destination, and provides guidance to guide the vehicle 2 traveling along the travel route to the destination. The navigation system 60 causes a touch panel display (not illustrated) to display map information and guidance information, specifies a destination input by the user performing an operation on the touch panel, and displays choices of a plurality of travel routes to the specified destination. Further, the navigation system 60 stores a travel history (such as travel time, amount of consumed power, and travel distance) during travel in a database etc.

The user of the vehicle 2 configured as discussed above occasionally charges the power storage device 20 mounted on the vehicle 2 using the charging/discharging station 300 installed at a facility other than home. In this case, the user can make effective use of a waiting time until charging is completed by using services provided around the charging/discharging station 300.

For example, when the charging/discharging station 300 is installed at a parking lot at an airport etc., the user can make effective use of a waiting time until charging of the power storage device 20 is completed by using facilities at the airport after the user parks the vehicle 2 in the parking lot and connects the vehicle 2 to the charging/discharging station 300. After the user parks the vehicle 2 in the parking lot and connects the vehicle 2 to the charging/discharging station 300, alternatively, the user can avoid occurrence of a waiting time for charging of the power storage device 20 by leaving the airport by airplane and allowing the charging to be completed by the time when the user returns to the airport. To that end, use of the charging/discharging station 300 is occasionally reserved in consideration of use of such services.

The charging/discharging station 300 is occupied for a long period when the user that has reserved use of the charging/discharging station 300 uses other services or goes out for a trip after connecting the vehicle 2 to the reserved charging/discharging station 300 at an airport etc. Therefore, other users may not use the charging/discharging station 300 during the period for which the charging/discharging station 300 is occupied.

Thus, in the present embodiment, the information management system 1 including the management server 100 and the first terminal 200 is characterized as follows. The first terminal 200 transmits, to the management server 100 (and finally to the second terminal 202), information for temporarily providing an authority for use of the battery electric vehicle to a renting person that rents the vehicle 2 during a reservation time. The management server 100 receives, from the first terminal 200, information for temporarily providing an authority for use of the battery electric vehicle to the renting person that rents the vehicle 2 during the reservation time.

This allows the renting person that rents the vehicle 2 to use the vehicle 2 during the period of use of the charging/discharging station 300, and enables the charging/discharging station 300 to be used during use of the vehicle 2 by the renting person, allowing the vehicle 2 and the charging/discharging station 300 to be used effectively when a reservation is made for a long period of use of the charging device.

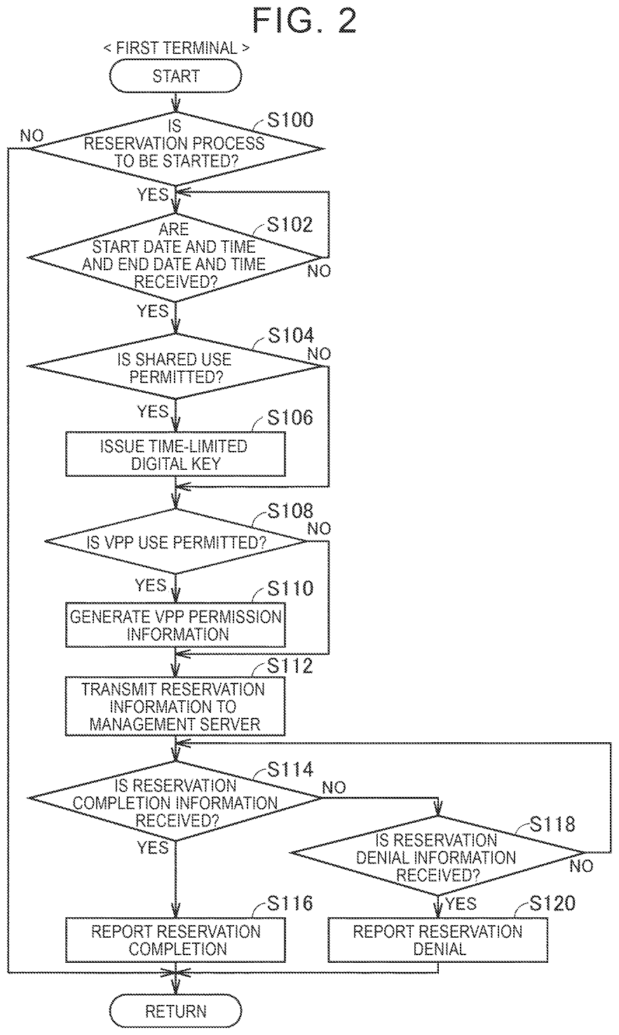

An example of a process executed by the first terminal 200 (specifically, the control device 200a) will be described below with reference to FIG. 2. FIG. 2 is a flowchart illustrating an example of a process executed by the first terminal 200. The process illustrated in the flowchart is executed by the control device 200a of the first terminal 200 repeatedly in predetermined control cycles.

In step (hereinafter denoted as “S”) 100, the first terminal 200 determines whether a reservation process is to be started. In the reservation process, the user of the vehicle 2 makes a reservation for use of the charging/discharging station 300 using the first terminal 200. The first terminal 200 determines that a reservation process is to be started when an operation to start a reservation process is received via the UI 200c while an app for enabling execution of a reservation process is started, for example. When it is determined that a reservation process is to be started (YES in S100), the process proceeds to S102.

In S102, the first terminal 200 determines whether a date and time (hereinafter referred to as a “start date and time”) when use of the charging/discharging station 300 is expected to be started and a date and time (hereinafter referred to as an “end date and time”) when use of the charging/discharging station 300 is expected to be ended have been received. The first terminal 200 makes display that enables input of a start date and time and an end date and time on the UI 200c when a reservation process is started, for example. The first terminal 200 determines whether a start date and time and an end date and time are input via the UI 200c. The first terminal 200 determines that a start date and time and an end date and time have been received when the user inputs a start date and time and an end date and time using the touch panel of the UI 200c, for example. When it is determined that a start date and time and an end date and time have been received (YES in S102), the process proceeds to S104.

In S104, the first terminal 200 determines whether use (hereinafter referred to as “shared use”) of the vehicle 2 parked in a parking space corresponding to the charging/discharging station 300 as a shared car or a rented car is permitted during the period of use of the charging/discharging station 300. The first terminal 200 displays an item that enables a user operation to select whether to permit shared use, in addition to an item for inputting a start date and time and an end date and time, on the screen displayed when the reservation process is started, for example. The first terminal 200 determines whether shared use is permitted using the state of selection of the item. When it is determined that shared use is permitted (YES in S104), the process proceeds to S106.

In S106, the first terminal 200 issues a time-limited digital key. A digital key functions with an app to be started on the first terminal 200, for example. When authentication is performed using the digital key when communication is made between the first terminal 200 and the vehicle 2, it is permitted to lock and unlock the doors of the vehicle 2 and perform driving operations (hereinafter occasionally simply referred to as “use”). The time-limited digital key has a part of the authority of the digital key discussed above to use the vehicle 2. Specifically, the time-limited digital key has the function of the digital key for a limited period determined in advance. The first terminal 200 generates a time-limited digital key that permits use of the vehicle 2 for a period of use since the start date and time until the end date and time, for example. After that, the process proceeds to S108. Also when it is determined that shared use is not permitted (NO in S104), the process proceeds to S108.

In S108, the first terminal 200 determines whether use (hereinafter referred to as “VPP use”) of the vehicle 2 as a small-scale power supply facility to be used for a virtual power plant (VPP) during the period of use of the charging/discharging station 300 is permitted. The first terminal 200 displays an item that enables a user operation to select whether to permit VPP use, in addition to an item for inputting a start date and time and an end date and time, on the screen displayed when the reservation process is started, for example. The first terminal 200 determines whether VPP use is permitted using the state of selection of the item. When it is determined that VPP use is permitted (YES in S108), the process proceeds to S110.

In S110, the first terminal 200 generates information (hereinafter referred to as “VPP permission information”) indicating that VPP use is permitted. After that, the process proceeds to S112.

In S112, the first terminal 200 transmits reservation information to the management server 100. The reservation information includes input information constituted from the start date and time and the end date and time. When shared use is permitted, the reservation information further includes information about the time-limited digital key. When VPP use is permitted, the reservation information further includes the VPP permission information. After that, the process proceeds to S114. Also when VPP use is not permitted (NO in S108), the process proceeds to S114.

In S114, the first terminal 200 determines whether reservation completion information has been received from the management server 100. The reservation completion information includes information indicating that registration of a reservation has been completed in the management server 100. When it is determined that reservation completion information has been received from the management server 100 (YES in S114), the process proceeds to S116.

In S116, the first terminal 200 reports reservation completion. Specifically, the first terminal 200 may display information that indicates reservation completion using the display device of the UI 200c, or may report information that indicates reservation completion using a voice or a notification sound from a speaker of the UI 200c. After that, this process is ended. When it is determined that reservation completion information has not been received (NO in S114), the process proceeds to S118.

In S118, the first terminal 200 determines whether reservation denial information has been received from the management server 100. The reservation denial information includes information indicating that a reservation was not received. When it is determined that reservation denial information has been received from the management server 100 (YES in S118), the process proceeds to S120.

In S120, the first terminal 200 reports reservation denial. Specifically, the first terminal 200 may display information that indicates reservation denial using the display device of the UI 200c, or may report information that indicates reservation denial using a voice or a notification sound from the speaker of the UI 200c. After that, this process is ended. When it is determined that reservation denial information has not been received (NO in S118), the process returns to S114. When it is determined that a reservation process is not to be started (NO in S100), the process is ended. When it is determined that a start date and time and an end date and time have not been received (NO in S102), the process returns to S102.

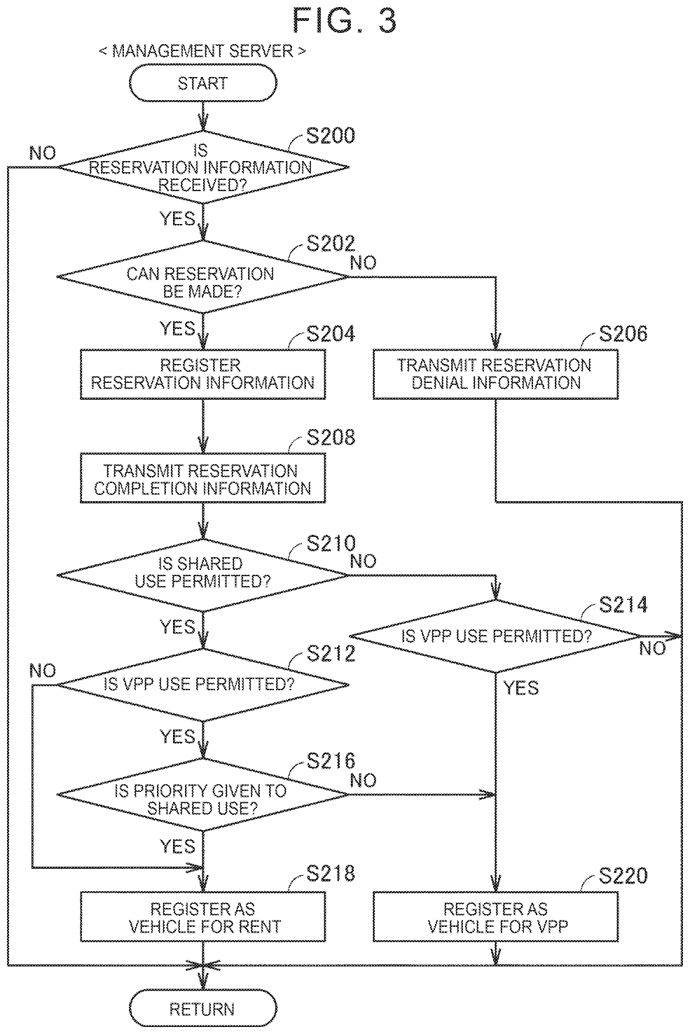

Next, an example of a process of registering reservation information executed by the management server 100 (specifically, the control device 11) will be described with reference to FIG. 3. FIG. 3 is a flowchart illustrating an example of a process of registering reservation information executed by the management server 100. The process illustrated in the flowchart is executed by the control device 11 of the management server 100 repeatedly in predetermined control cycles.

In S200, the management server 100 determines whether reservation information has been received from the first terminal 200. The reservation information has been discussed above, and therefore detailed description thereof will not be repeated. When it is determined that reservation information has been received from the first terminal 200 (YES in S200), the process proceeds to S202.

In S202, the management server 100 determines whether a reservation can be made using input information included in the reservation information. The management server 100 determines that a reservation can be made when there is a vacancy for a reservation in an expected period of use (parking use period) since the start date and time until the end date and time included in the input information (i.e. when there is no other reservation for use of the charging/discharging station 300). When there is a plurality of charging/discharging stations 300, the management server 100 may determine that a reservation can be made when there is a vacancy for a reservation in an expected period of use at at least any of the charging/discharging stations 300. When it is determined that a reservation can be made (YES in S202), the process proceeds to S204.

In S204, the management server 100 registers the reservation information in the storage device 15. After that, the process proceeds to S208. When it is determined that a reservation cannot be made (NO in S202), the process proceeds to S206.

In S206, the management server 100 transmits reservation denial information to the first terminal 200. The reservation denial information has been discussed above, and therefore detailed description thereof will not be repeated. After that, the process is ended.

In S208, the management server 100 transmits reservation completion information to the first terminal 200. The reservation completion information has been discussed above, and therefore detailed description thereof will not be repeated. After that, the process proceeds to S210.

In S210, the management server 100 determines whether shared use of the vehicle 2 is permitted. The management server 100 determines that shared use of the vehicle 2 is permitted when a time-limited digital key is included in the received reservation information. When it is determined that shared use of the vehicle 2 is permitted (YES in S210), the process proceeds to S212.

In S212, the management server 100 determines whether VPP use of the vehicle 2 is permitted. The management server 100 determines that VPP use of the vehicle 2 is permitted when VPP permission information is included in the received reservation information. When it is determined that VPP use of the vehicle 2 is permitted (YES in S212), the process proceeds to S216. When it is determined that shared use of the vehicle 2 is not permitted (NO in S210), the process proceeds to S214.

In S214, the management server 100 determines whether VPP use of the vehicle 2 is permitted. The method of determining whether VPP use is permitted is the same as the determination method in the process in S212, and therefore detailed description thereof will not be repeated. When it is determined that VPP use is permitted (YES in S214), the process proceeds to S220.

In S216, the management server 100 determines whether a priority is given to shared use of the vehicle 2 over VPP use. The management server 100 determines whether a priority is given to shared use over VPP use using the state, specifications, etc. of the vehicle 2.

The management server 100 may determine that a priority is given to VPP use over shared use when the full charge capacity of the power storage device 20 mounted on the vehicle 2 is more than a threshold and it is determined that the vehicle 2 is suitable for VPP use, and may determine that a priority is given to shared use over VPP use when the full charge capacity of the power storage device 20 is not more than the threshold, for example. The management server 100 may acquire the full charge capacity of the power storage device 20 by way of the first terminal 200, or may acquire the full charge capacity of the power storage device 20 by communicating with the vehicle 2.

Alternatively, the management server 100 may determine that a priority is given to VPP use over shared use when the distance from the home of the user (or the position of the vehicle 2 or the first terminal 200) registered in advance to the charging/discharging station 300 is more than a threshold, since SOC has been consumed at the time of arrival at the charging/discharging station 300, and may determine that a priority is given to shared use over VPP use when the distance is not more than the threshold, for example. The management server 100 may acquire information about the specifications or the state of the vehicle 2 from the first terminal 200 or the vehicle 2, or such information may be included in the reservation information. Alternatively, the management server 100 may determine that a priority is given to VPP use over shared use when the period of use of the charging/discharging station 300 is less than a lower limit value of a period for which shared use is enabled, and may determine that a priority is given to shared use over VPP use when the period of use is not less than the lower limit value, for example. When it is determined that a priority is given to shared use over VPP use (YES in S216), the process proceeds to S218. When it is determined in S212 that VPP use is not permitted (NO in S212), the process proceeds to S218.

In S218, the management server 100 registers the vehicle 2 as a vehicle for rent. The management server 100 sets a part of the reserved period of use of the charging/discharging station 300 since the start date and time until the end date and time as a sharable period of the vehicle 2. The sharable period is set within a part of the period of use excluding a secured charge period set immediately before the end date and time. The secured charge period may include a period determined in advance for which the power storage device 20 of the vehicle 2 can be reliably charged to a fully charged state. The sharable period may be set to a period excluding a secured charge period for shared use set immediately after the start date and time. After that, the process is ended. When it is determined that a priority is not given to shared use over VPP use (NO in S216), the process proceeds to S220.

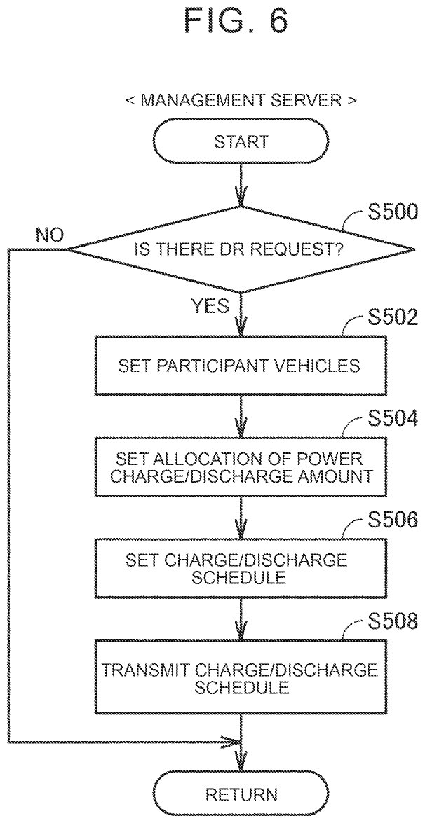

In S220, the management server 100 registers the vehicle 2 as a vehicle for VPP. The management server 100 registers the vehicle 2 as a select candidate (i.e. a vehicle for VPP) for a vehicle that participates in a DR request in response to a DR request from the aggregator server 102 in the process to be discussed later with reference to FIG. 6. After that, the process is ended. When it is determined that request information has not been received (NO in S200), the process is ended thereafter. When neither shared use nor VPP use is permitted (NO in S210 and NO in S214), further, the process is ended thereafter.

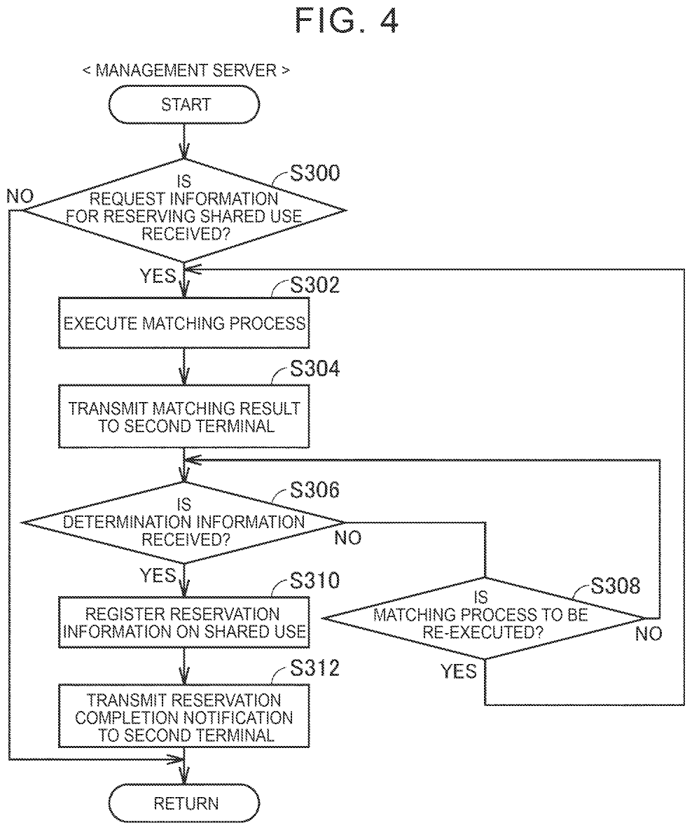

Next, an example of a process of reserving shared use executed by the management server 100 (specifically, the control device 11) will be described with reference to FIG. 4. FIG. 4 is a flowchart illustrating an example of a process of reserving shared use executed by the management server 100. The process illustrated in the flowchart is executed by the control device 11 of the management server 100 repeatedly in predetermined control cycles.

In S300, the management server 100 determines whether request information for reserving shared use has been received from the second terminal 202. The request information includes a rental use start date and time when rental use of the vehicle 2 is started and a rental use end date and time. The request information may include information such as a destination during rental use of the vehicle 2, for example. A user (hereinafter referred to as a “renting person”) of shared use inputs information including the rental use start date and time and the rental use end date and time when an app for shared use is started on the second terminal 202. The second terminal 202 generates request information using the input information, and transmits the generated request information to the management server 100. When it is determined that request information has been received from the second terminal 202 (YES in S300), the process proceeds to S302.

In S302, the management server 100 executes a matching process. The matching process includes a process of selecting a vehicle that meets conditions included in the request information, from a plurality of vehicles for rent. The management server 100 selects a vehicle that can be rented for at least a desired rental use period since the rental use start date and time until the rental use end date and time, from among the plurality of vehicles for rent. When there is a plurality of select candidates, the management server 100 selects one vehicle in accordance with an order of priority determined in advance. The order of priority may be set such that vehicles that use the charging/discharging station 300 are selected with higher orders of priority, for example. After that, the process proceeds to S304.

In S304, the management server 100 transmits the matching result (i.e. the vehicle selected through the matching process) to the second terminal 202. After that, the process proceeds to S306.

In S306, the management server 100 determines whether determination information has been received from the second terminal 202. The determination information includes information indicating that the renting person has determined the vehicle selected through the matching process as a vehicle to be rented. When it is determined that determination information has been received (YES in S306), the process proceeds to S310. When it is determined that determination information has not been received (NO in S306), the process proceeds to S308.

In S308, the management server 100 determines whether there is a re-matching request that requests re-execution of a matching process. The management server 100 determines that there is a re-matching request when a re-matching request is received from the second terminal 202. When it is determined that there is a re-matching request (YES in S308), the process returns to S302. When it is determined that there is not a re-matching request (NO in S308), the process returns to S306.

In S310, the management server 100 registers request information on shared use. The management server 100 causes the storage device 15 to store information about the selected vehicle and information about the desired rental use period for the selected vehicle as reservation information, for example. After that, the process proceeds to S312.

In S312, the management server 100 transmits a reservation completion notification to the second terminal 202. After that, the process is ended. When it is determined that reservation information has not been received (NO in S300), the process is ended.

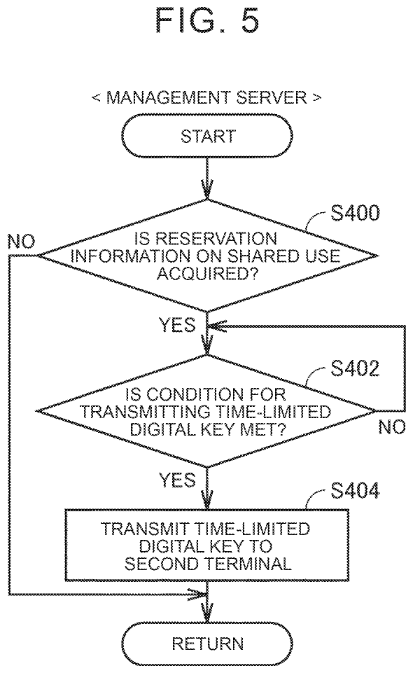

Next, an example of a process of transmitting a time-limited digital key executed by the management server 100 (specifically, the control device 11) will be described with reference to FIG. 5. FIG. 5 is a flowchart illustrating an example of a process of transmitting a time-limited digital key executed by the management server 100. The process illustrated in the flowchart is executed by the control device 11 of the management server 100 repeatedly in predetermined control cycles.

In S400, the management server 100 acquires reservation information on shared use. The reservation information on shared use has been discussed above, and therefore detailed description thereof will not be repeated. When reservation information is stored in the storage device 15, the management server 100 acquires the reservation information by reading the reservation information from the storage device 15. After that, the process proceeds to S402.

In S402, the management server 100 determines whether a condition for transmitting a time-limited digital key is met. The condition for transmitting a time-limited digital key may include a condition that it is past a time a period determined in advance before the rental use start date and time of the selected vehicle, may include a condition that the distance between the position of the second terminal 202 and the selected vehicle is a threshold or less, or may include a condition that it is within the desired rental use period of the selected vehicle, for example. When it is determined that the condition for transmitting a time-limited digital key is met (YES in S402), the process proceeds to S404.

In S404, the management server 100 transmits a time-limited digital key to the second terminal 202. When it is determined that reservation information is not acquired (NO in S400), the process is ended. When it is determined that the condition for transmitting a time-limited digital key is not met (NO in S402), further, the process returns to S402.

Next, an example of a process of setting a participant vehicle for a DR request executed by the management server 100 (specifically, the control device 11) will be described with reference to FIG. 6. FIG. 6 is a flowchart illustrating an example of a process of setting a participant vehicle for a DR request executed by the management server 100. The process illustrated in the flowchart is executed by the control device 11 of the management server 100 repeatedly in predetermined control cycles.

In S500, the management server 100 determines whether there is a DR request. The management server 100 determines that there is a DR request when information that indicates a DR request is received from the aggregator server 102, for example.

The aggregator server 102 transmits a DR request to small-scale power supply facilities, including the management server 100, in accordance with the difference between the amount of power that can be supplied in a power network to be subjected to the supply and demand adjustment and an estimated value of the amount of power demanded in the power network, for example. When a period in which the amount of power that can be supplied in the power network is more than the amount of demanded power is expected, the aggregator server 102 makes an upward DR request to increase the amount of demanded power in the period, for example. When a period in which the amount of power that can be supplied in the power network is less than the amount of demanded power is expected, the aggregator server 102 makes a downward DR request to decrease the amount of demanded power in the period, for example. The aggregator server 102 transmits a DR request amount to the small-scale power supply facilities together with the upward DR request or the downward DR request. When it is determined that there is a DR request (YES in S500), the process proceeds to S502.

In S502, the management server 100 sets participant vehicles. The management server 100 sets participant vehicles from a plurality of vehicles for VPP which are connected to the charging/discharging station 300 and of which VPP use is permitted. When the DR request is an upward DR request, the management server 100 may set, as participant vehicles, vehicles with a power storage device with low SOC, among the plurality of vehicles for VPP, for example. When the DR request is a downward DR request, alternatively, the management server 100 may set, as participant vehicles, vehicles with a power storage device with high SOC, among the plurality of vehicles for VPP, for example. Alternatively, the management server 100 may set all the vehicles for VPP as participant vehicles. After that, the process proceeds to S504.

In S504, the management server 100 sets the power charge/discharge amount allocated to each of the participant vehicles. The management server 100 sets the allocated power charge/discharge amount on the basis of the present SOC, full charge capacity, etc. of each of the participant vehicles, for example. After that, the process proceeds to S506.

In S506, the management server 100 sets a charge/discharge schedule for each of the participant vehicles. The charge/discharge schedule includes information about a time slot for charge/discharge for achieving the power charge/discharge amount allocated to each of the participant vehicles and charge/discharge power, for example. The charge/discharge schedule is set for each of the participant vehicles.

In S508, the management server 100 transmits the set charge/discharge schedule to the corresponding participant vehicle or the charging/discharging station to which the participant vehicle is connected. In each of the participant vehicles, charge/discharge control for the power storage device is performed in accordance with the received charge/discharge schedule. After that, the process is ended. When it is determined that there is not a DR request (NO in S500), the process is ended.

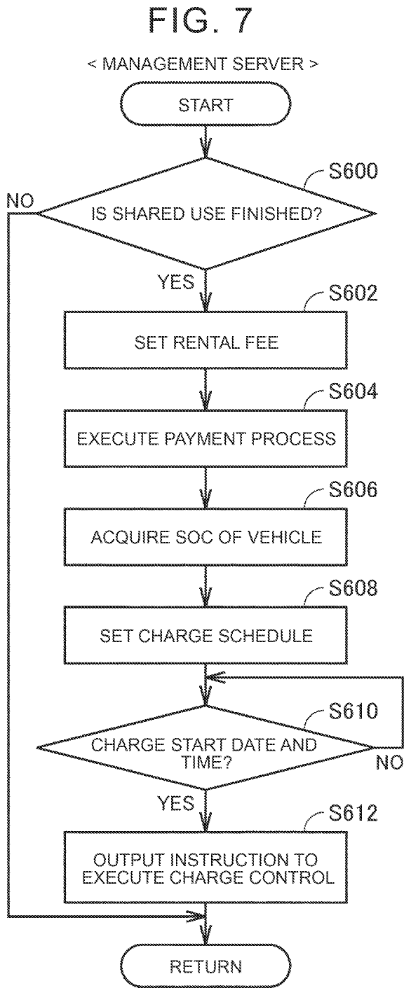

Next, an example of a process of setting a charge schedule executed by the management server 100 (specifically, the control device 11) will be described with reference to FIG. 7. FIG. 7 is a flowchart illustrating an example of a process of setting a charge schedule executed by the management server 100. The process illustrated in the flowchart is executed by the control device 11 of the management server 100 repeatedly in predetermined control cycles.

In S600, the management server 100 determines whether shared use has been finished. The management server 100 may determine that shared use has been finished when information that shared use has been finished is received from the second terminal 202 and the vehicle for shared use is connected to the charging/discharging station 300, for example. The renting person performs an operation to finish shared use using the second terminal 202 after parking the rented vehicle in the parking space in which the vehicle had been when shared use was started and connecting the connector 304 of the charging/discharging station 300 to the inlet 40, for example. At this time, the second terminal 202 transmits information that shared use has been finished to the management server 100 in accordance with the operation. On the other hand, the charging/discharging station 300 acquires information (vehicle ID) on the connected vehicle 2 when the connector 304 is connected to the inlet 40 of the vehicle 2, and transmits information indicating that the vehicle 2 has been connected to the charging/discharging station 300 and the travel history of the vehicle 2 to the management server 100. These pieces of information may be transmitted from the vehicle 2 to the management server 100, or may be transmitted to the management server 100 by way of the second terminal 202.

In S602, the management server 100 sets a fee (hereinafter referred to as a “rental fee”) for shared use. The management server 100 may set a rental fee using the travel history of the vehicle 2, for example. The management server 100 may set a rental fee using the travel distance during the period of shared use and the rental fee per unit distance, for example. Alternatively, the management server 100 may set a rental fee using the travel time during the period of shared use and the rental fee per unit time, for example. Alternatively, the management server 100 may set a rental fee using the period of shared use and the rental fee per unit time, for example. After that, the process proceeds to S604.

In S604, the management server 100 executes a payment process. When the renting person has registered a payment method such as electronic settlement such as credit card settlement in advance, the management server 100 executes a payment process using the registered payment method, for example. After that, the process proceeds to S606.

In S606, the management server 100 acquires the SOC of the vehicle for shared use. The management server 100 acquires the SOC of the vehicle using the travel history of the vehicle 2 acquired by way of the charging/discharging station 300. After that, the process proceeds to S608.

In S608, the management server 100 sets a charge schedule for the vehicle for shared use. The management server 100 sets a date and time (hereinafter referred to as a “charge start date and time”) to start charge such that the power storage device mounted on the vehicle for shared use will be in a charge state (e.g. a fully charged state) determined in advance at the end date and time, for example. When the vehicle is expected to be used as a reserved VPP for the next shared use, the management server 100 sets a charge start date and time such that the power storage device will be in a charge state determined in advance at a use start date and time for shared use or a use start date and time for VPP use, for example.

In S610, the management server 100 determines whether the present date and time is past the charge start date and time. When it is determined that the present date and time is past the charge start date and time (YES in S610), the process proceeds to S612.

In S612, the management server 100 outputs an instruction to execute charge control to the charging/discharging station 300 to which the vehicle for shared use is connected. The charging/discharging station 300 receives an instruction to execute charge control from the management server 100, and charges the power storage device mounted on the vehicle connected to the charging/discharging station 300. The management server 100 may output an instruction to execute charge control to the vehicle for shared use. After that, the process is ended. When it is determined that shared use has not been finished (NO in S600), the process is ended. When it is determined that the present date and time is not past the charge start date and time (NO in S610), meanwhile, the process returns to S610.

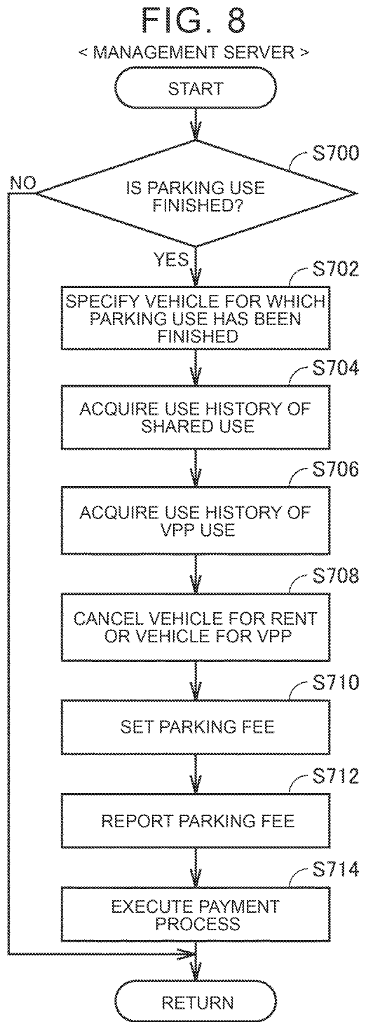

Next, an example of a process of setting a parking fee executed by the management server 100 (specifically, the control device 11) will be described with reference to FIG. 8. FIG. 8 is a flowchart illustrating an example of a process of setting a parking fee executed by the management server 100. The process illustrated in the flowchart is executed by the control device 11 of the management server 100 repeatedly in predetermined control cycles.

In S700, the management server 100 determines whether parking use has been finished. The management server 100 may determine that parking use has been finished when information that parking use has been finished is received from the first terminal 200 and the vehicle for parking use is disconnected from the charging/discharging station 300, for example. The owner of the vehicle performs an operation to finish parking use using the first terminal 200, for example. At this time, the first terminal 200 transmits information that parking use has been finished to the management server 100 in accordance with the operation. On the other hand, the charging/discharging station 300 transmits information indicating that the vehicle for parking use is disconnected from the charging/discharging station 300 to the management server 100 when the connector 304 is detached from the inlet 40 of the vehicle. These pieces of information may be transmitted from the vehicle 2 to the management server 100, or may be transmitted to the management server 100 by way of the first terminal 200. When it is determined that parking use has been finished (YES in S700), the process proceeds to S702.

In S702, the management server 100 specifies a vehicle for which parking use has been finished. The management server 100 may specify a vehicle for which parking use has been finished by acquiring a vehicle ID from the first terminal 200, for example. After that, the process proceeds to S704.

In S704, the management server 100 acquires a use history of shared use. The management server 100 acquires a use history of shared use by reading, from the storage device 15, a shared use period, a travel distance, a travel time, a rental fee, etc. during shared use of the specified vehicle. The management server 100 may acquire these pieces of information from the specified vehicle, or may acquire such information from the vehicle by way of the first terminal 200.

In S706, the management server 100 acquires a use history of VPP use. The management server 100 acquires a use history of VPP use by reading, from the storage device 15, a charge/discharge period, a charge amount, a discharge amount, etc. during VPP use of the specified vehicle. The management server 100 may acquire these pieces of information from the specified vehicle, or may acquire such information from the vehicle by way of the first terminal 200.

In S708, the management server 100 cancels setting as a vehicle for rent when the vehicle for which parking use has been finished has been set as a vehicle for rent, and cancels setting as a vehicle for VPP when the vehicle for which parking use has been finished has been set as a vehicle for VPP. When setting as a vehicle for rent is canceled, the vehicle is excluded from select candidates during the matching process, for example. When setting as a vehicle for VPP is canceled, meanwhile, the vehicle is excluded from select candidates for setting participant vehicles in accordance with a DR request. After that, the process proceeds to S710.

In S710, the management server 100 sets a parking fee. The management server 100 sets a parking fee using a period of use, a use history of shared use during the period of use, a use history of VPP use during the period of use, and an amount of charge performed before the end of use, for example. The management server 100 sets a reference parking fee based on the period of use, for example. The management server 100 sets a discount fee using the period of use, the travel distance, etc. during shared use. The management server 100 sets a discount fee using the period of use, the charge amount or the discharge amount, the degree of contribution, etc. during VPP use. The management server 100 sets an additional fee using the amount of charge performed before the end of use. The management server 100 sets a final parking fee based on the reference parking fee, the discount fee, and the additional fee.

In S712, the management server 100 reports the set parking fee. The management server 100 reports the set parking fee to the first terminal 200 of the user that owns the vehicle for which use has been finished.

In S714, the management server 100 executes a payment process. When the user of the parking lot has registered a payment method such as electronic settlement such as credit card settlement in advance, the management server 100 executes a payment process using the registered payment method. After that, the process is ended. When it is determined that parking use has not been finished (NO in S700), the process is ended.

An example of operation of the management server 100 based on the structures and the flowcharts described above will be described.

When Only Shared Use Is Permitted

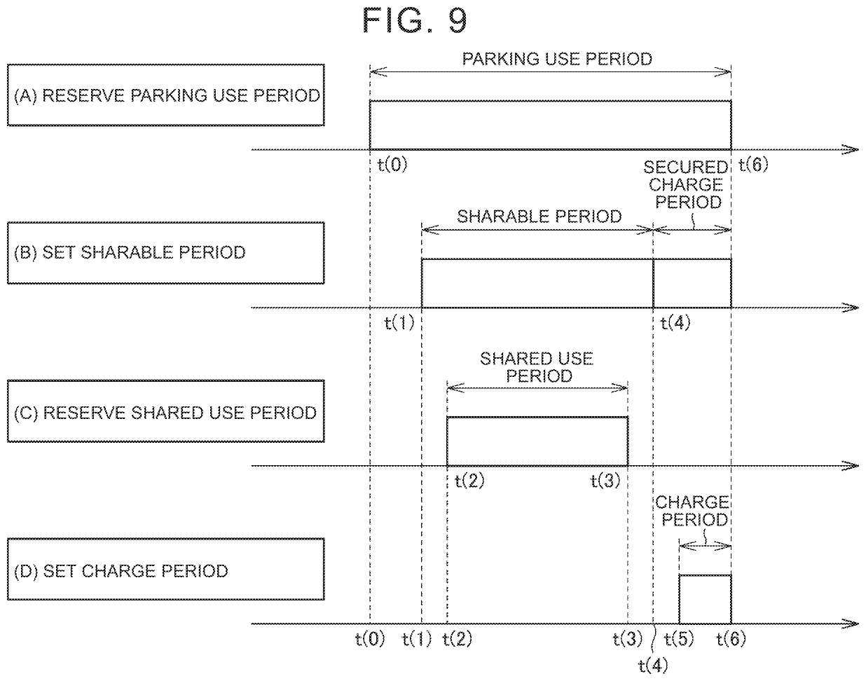

FIG. 9 is a timing chart illustrating an example of operation of the management server 100 for a case where only shared use is permitted. FIG. 9 indicates a parking use period, a sharable period, a secured charge period, a shared use period, and a charge period. These periods are set through operation of the management server 100, the first terminal 200, and the second terminal 202 as described below.

When the user of the vehicle 2 operates the first terminal 200 to start an app for reserving a parking lot and start a reservation process (YES in S100), a start date and time and an end date and time are received (S102). At this time, it is assumed that it is selected to permit only shared use. When a start date and time and an end date and time are received as input information (YES in S102), and when shared use is permitted (YES in S104), a time-limited digital key is issued (S106). On the other hand, VPP use is not permitted (NO in S108), and therefore VPP permission information is not generated, and reservation information including the input information and the time-limited digital key is transmitted to the management server 100 (S112).

In the management server 100, when reservation information is received (YES in S200) and it is determined that a reservation can be made (YES in S202), the reservation information is registered (S204).

At this time, a reservation is made for a period of use in which a parking lot is expected to be used since time t(0) as the start date and time until time t(6) as the end date and time as indicated in (A) of FIG. 9. When the reservation information is registered, reservation completion information is transmitted to the first terminal 200 (S208).

When reservation completion information has been received in the first terminal 200 (YES in S114), the UI 200c is notified that a reservation has been completed (S116).

In the management server 100, when shared use of the vehicle 2 is permitted (YES in S210) after the transmission of reservation completion information, and when VPP use is not permitted (NO in S212), the vehicle 2 is registered as a vehicle for rent (S218). At this time, a sharable period of the registered vehicle for rent is set within the period of use of the parking lot as indicated in (B) of FIG. 9. More specifically, a period that starts at time t(1) a time determined in advance past the start date and time t(0) of the parking use period and that ends at time t(4) a secured charge period before the end date and time t(6) of the parking use period is set as the sharable period.

Therefore, request information is transmitted to allow a renting person to reserve shared use using the second terminal 202, and when the request information is received by the management server 100 (YES in S300), a matching process for extracting a select candidate from among a plurality of vehicles for rent is executed (S302). A matching result obtained through the matching process is transmitted to the second terminal 202 (S304).

When determination information indicating that shared use of the select candidate included in the matching result has been determined is received from the second terminal 202 (YES in S306), reservation information on the shared use is registered, and a reservation completion notification is transmitted to the second terminal 202.

It is assumed that the period of shared use desired by the renting person has time t(2), after time t(1), as the use start date and time and time t(3), before time t(4), as the use end date and time as indicated in (C) of FIG. 9, for example.

When reservation information for shared use is acquired (YES in S400), the management server 100 determines whether a condition for transmitting a time-limited digital key is met (S402). When the transmission condition is met (YES in S402) with the period since the present date and time until the rental use start date and time being shorter than a threshold etc., a time-limited digital key is transmitted to the second terminal 202 (S404). When a time-limited digital key is transmitted to the second terminal 202, the renting person that is the owner of the second terminal 202 is enabled to use the vehicle 2 parked in the parking lot.

When the renting person parks the vehicle 2 in the parking lot at time t(3) after use and connects the connector 304 to the inlet 40 to finish shared use (YES in S600), a rental fee for the shared use is set (S602), and a payment process is executed (S604).

At this time, the SOC of the power storage device 20 mounted on the vehicle 2 is acquired (S606), and a charge schedule is set (S608). That is, in the management server 100, an amount of power corresponding to the difference between the SOC corresponding to a charge state, determined in advance, of the power storage device 20 mounted on the vehicle 2 and the present SOC is calculated. Then, charge start date and time t(5) is set such that charge for the calculated amount of power is finished at time t(6).

Then, at time t(5) (YES in S610), an instruction to execute charge control is output (S612), and the power storage device 20 mounted on the vehicle 2 is charged. At time t(6), the power storage device mounted on the vehicle 2 is charged to a charge state determined in advance. At this time, when the owner of the vehicle 2 performs an operation to finish parking use (YES in S700), the vehicle 2 for which parking use has been finished is specified in the management server 100 (S702). Then, a use history of shared use of the specified vehicle 2 is acquired (S704), and a use history of VPP use (no VPP use) is acquired (S706).

Then, setting of the vehicle for rent is canceled (S708), and a parking fee is set (S710). After that, the first terminal 200 is notified of the set parking fee (S712), and a payment process is executed (S714).

When VPP Use Is Permitted

When only VPP use is permitted, a VPP enabled period is set in place of the sharable period in FIG. 9, and a VPP use period is set in place of the shared use period. A VPP enabled period and a VPP use period are set as follows. The other periods are set as described with reference to FIG. 9, and therefore detailed description thereof will not be repeated.

When the user reserves use of a parking lot, and when shared use is not permitted (NO in S104) and only VPP use is permitted (YES in S108), a time-limited digital key is not issued, and VPP use permission information is generated (S110), for example. Therefore, VPP use permission information is transmitted, in addition to input information, to the management server 100 as reservation information (S112).

In this case, when reservation information is received (YES in S200), a reservation can be made (YES in S202), and the reservation information is registered (S204), reservation completion information is transmitted (S208). Then, since shared use is not permitted (NO in S210) and VPP use is permitted (YES in S214), the vehicle is registered as a vehicle for VPP (S220). In a vehicle for VPP, a VPP enabled period is set in place of the sharable period indicated in (B) of FIG. 9.

Therefore, when a DR request period is included within the VPP enabled period when there is a DR request (YES in S500) and participant vehicles are set (S502), the vehicle 2 is extracted as a select candidate. Allocation of a charge/discharge power amount to each participant vehicle is set (S504), and a charge/discharge schedule for achieving the allocated charge/discharge power amount is set (S506). Then, the charge schedule is transmitted to the charging/discharging station 300 (S508). As a result, charge/discharge control in which the power storage device 20 mounted on the vehicle 2 is used is executed during the DR request period, contributing to power supply and demand adjustment.

When both shared use and VPP use are permitted (YES in S210 and YES in S212), it is determined whether a priority is given to shared use (S216).

When the full charge capacity of the power storage device 20 mounted on the vehicle 2 is more than a threshold, it is determined that a priority is given to VPP use (NO in S216), and the vehicle 2 is registered as a vehicle for VPP (S220), for example. When the full charge capacity of the power storage device 20 mounted on the vehicle 2 is not greater than the threshold, on the other hand, it is determined that a priority is given to shared use (YES in S216), and the vehicle 2 is registered as a vehicle for rent (S218).

With the information management system 1 according to the present embodiment, as described above, a user that is different from the user that owns the vehicle 2 is allowed to use the vehicle 2 during the period of use of the charging/discharging station 300, and the charging/discharging station 300 can be used during use of the vehicle 2 by the user, allowing the vehicle 2 and the charging/discharging station 300 to be used effectively when a reservation is made for a long period of use of the charging/discharging station 300. Thus, it is possible to provide an information management system and an information management method that allow effective use of a vehicle and a charging device that charges a power storage device mounted on the vehicle when the charging device is occupied for a long period.

Further, a set period set within a reserved period of use of a charging device is set as a period during which a renting person can use the vehicle 2, and therefore it is possible to allow the renting person to use the vehicle 2 within the period, and enable use of the charging/discharging station 300 during use of the vehicle 2 by the renting person. Therefore, the vehicle 2 and the charging/discharging station 300 can be used effectively when a reservation is made for a long period of use of the charging/discharging station 300.

When a period during which the renting person can use the vehicle 2 is set within a period of use, further, the renting person is allowed to use the vehicle 2 in the period, and the charging/discharging station can be used during use of the vehicle 2 by the renting person. When a period during which power supply and demand adjustment is performed is set within a period of use, further, the vehicle 2 can be used for power supply and demand adjustment, achieving balance between power supply and demand in the power network.

Further, an authority for use of the battery electric vehicle can be temporarily given to the renting person using a time-limited digital key, and therefore the renting person is allowed to use the vehicle 2 during the period of use of the charging/discharging station 300.

Further, the power storage device 20 of the vehicle 2 can be brought to a charge state (fully charged state) determined in advance when the period of use is finished, by setting a secured charge period before the period of use is finished.

Modifications will be described below. While a single processor and a single memory execute a process in the first terminal 200 in the embodiment discussed above, by way of example, the process in the flowchart illustrated in FIG. 2 may be executed by two or more processors reading and executing a program stored in two or more memories.

While a single processor 11a and a single memory 11b execute a process in the control device 11 of the management server 100 in the embodiment discussed above, by way of example, the processes in the flowcharts illustrated in FIGS. 3 to 8 may be executed by two or more processors reading and executing programs stored in two or more memories.

Further, while the vehicle 2 is set to one of a vehicle for rent and a vehicle for VPP in a period of use of a parking lot in the embodiment discussed above, by way of example, the vehicle 2 may be set as a vehicle for VPP after being set as a vehicle for rent, or may be set as a vehicle for rent after being set as a vehicle for VPP, during a period of use. For example, the vehicle 2 may be set as a vehicle for rent to be subjected to shared use, and thereafter set as a vehicle for VPP when the SOC of the power storage device 20 is in a first range determined in advance and suitable for VPP use. Alternatively, the vehicle 2 may be set as a vehicle for VPP to be subjected to VPP use, and thereafter set as a vehicle for rent when the SOC of the power storage device 20 is in a second range (that is different from the first range) determined in advance suitable for shared use.

Another aspect of the present disclosure provides an information management method, including: a terminal notifying a user that uses a battery electric vehicle of reservation information for reserving use of a charging device configured to charge a power storage device mounted on a battery electric vehicle; and the terminal transmitting information for temporarily providing an authority for use of the battery electric vehicle to a renting person that rents the battery electric vehicle during a reservation time.

All or a part of the modifications described above may be combined as appropriate to be implemented. The embodiment disclosed herein should be considered to be illustrative and not restrictive in all respects. The scope of the present disclosure is set forth by the claims, rather than the above description, and is intended to include all modifications within the meaning and scope equivalent to the claims.

What is claimed is:

1. An information management system comprising a server configured to
manage reservation information for reserving use of a charging device configured to charge a power storage device mounted on a battery electric vehicle, and
receive information for temporarily providing an authority for use of the battery electric vehicle to a renting person that rents the battery electric vehicle during a reservation time.

2. The information management system according to claim 1, wherein the server is configured to set a set period set within a reserved period of the use of the charging device as a first period during which the renting person is enabled to use the battery electric vehicle.

3. The information management system according to claim 1, wherein the server is configured to set a set period set within a reserved period of the use of the charging device as one of a first period during which the renting person is enabled to use the battery electric vehicle and a second period during which power supply and demand is adjusted.

4. The information management system according to claim 1, further comprising a terminal configured to communicate with the server, wherein the terminal is configured to transmit a digital key to the server as the information for temporarily providing the authority for the use of the battery electric vehicle when reserving the use of the charging device, the digital key enabling the battery electric vehicle to be rented for a set period set within a period of the use of the charging device.

5. The information management system according to claim 1, wherein the server is configured to acquire information on at least one of a use history of the battery electric vehicle and a state of the battery electric vehicle during a period of the use of the charging device from the battery electric vehicle, and set a charge schedule for the power storage device using the acquired information.

6. An information management system comprising a terminal configured to
notify a user that uses a battery electric vehicle of reservation information for reserving use of a charging device configured to charge a power storage device mounted on the battery electric vehicle, and
transmit information for temporarily providing an authority for use of the battery electric vehicle to a renting person that rents the battery electric vehicle during a reservation time.

7. An information management method executed by a server, the information management method comprising:
managing reservation information for reserving use of a charging device configured to charge a power storage device mounted on a battery electric vehicle; and
receiving information for temporarily providing an authority for use of the battery electric vehicle to a renting person that rents the battery electric vehicle during a reservation time.
